(19) United States
(12) Patent Application Publication
(10) Pub. No.: US 2023/0311054 A1
(43) Pub. Date: Oct. 5, 2023

(54) AIR TREATMENT DEVICE

(71) Applicant: Dyson Technology Limited, Wiltshire (GB)

(72) Inventors: Philip Tennison REILLY, Gloucester (GB); Ben Thomas EDMONDS, Swindon (GB)

(73) Assignee: Dyson Technology Limited, Wiltshire (GB)

(21) Appl. No.: 18/008,228

(22) PCT Filed: Apr. 22, 2021
(86) PCT No.: PCT/GB2021/050967

§ 371 Date: Dec. 5, 2022

(30) Foreign Application Priority Data
Jun. 16, 2020 (GB) 2009159.1

(51) Int. Cl. B01D 53/04; B01D 53/88

(52) U.S. Cl. CPC B01D 53/0438; B01D 53/885; B01D 2221/16; B01D 2253/102; B01D 2259/40088; B01D 2255/20707; B01D 2255/802

(57) ABSTRACT

There is provided an air-treatment device including an airflow generator for generating an airflow, an adsorbent material for adsorbing one or more airborne contaminants, the adsorbent material being arranged such that at least a portion of the airflow passes through the adsorbent material, a heater arranged to heat a portion of the adsorbent material to desorb adsorbed contaminants, and a photocatalytic reactor arranged to receive air containing the contaminants desorbed from the heated portion of adsorbent material. The photocatalytic reactor includes a photo-catalyst for photocatalytic degradation of one or more of the contaminants, and one or more light sources for illuminating the photo-catalyst to facilitate photocatalytic degradation. The air-treatment device is arranged such that at least a portion of the airflow that has not passed through the heated portion of the adsorbent material contacts the one or more light sources.

### FIELD OF THE INVENTION

The present invention relates to an air treatment device.

### BACKGROUND OF THE INVENTION

An air treatment device treats air to remove contaminants. Conventional air treatment devices solely use particulate filters that physically capture airborne particles by size exclusion, with a high-efficiency particulate air (HEPA) filter removing at least 99.97% of 0.3 μm particles. Some air treatment devices use activated carbon filters to filter volatile chemicals from the air. Activated carbons are well known carbonaceous materials that are processed to have a large number of open or accessible micropores and mesopores that increase the surface area available for adsorption or chemical reactions. For example, WO2016/128734 describes a fan assembly that has a tubular, barrel-type filter that is mounted on the cylindrical body of the fan assembly, The filter comprises a two-layer structure of filter media that includes an outer layer of a pleated HEPA filter surrounding an inner layer of activated carbon cloth.

When used for air purification, activated carbons filter out contaminants by adsorption, and therefore only have a limited capacity, such that activated carbon filters eventually require replacement if filtering performance is to be maintained. It is therefore desirable to be able to regenerate such absorption filters to avoid the need for replacement. An approach to achieving this regeneration is to thermally desorb the contaminants from the absorption filter before either emitting them into an external environment or destroying them using a technique such as photocatalytic oxidation (PCO), with the latter of these being preferable as it does not require that the air treatment device is able to vent to an external environment.

### SUMMARY OF THE INVENTION

According to a first aspect of the present invention there is provided an air-treatment device. The air-treatment device comprises an airflow generator for generating an airflow, an adsorbent material for adsorbing one or more airborne contaminants, the adsorbent material being arranged such that at least a portion of the airflow passes through the adsorbent material, a heater arranged to heat a portion of the adsorbent material to desorb adsorbed contaminants, and a photocatalytic reactor arranged to receive air containing the contaminants desorbed from the heated portion of adsorbent material. The photocatalytic reactor comprises a photo-catalyst for photocatalytic degradation of one or more of the contaminants, and one or more light sources for illuminating the photo-catalyst to facilitate photocatalytic degradation. The air-treatment device is arranged such that at least a portion of the airflow that has not passed through the heated portion of the adsorbent material contacts the one or more light sources.

The air treatment device may be configured to provide at least one airflow path that allows air from outside the air treatment device to contact at least one of the one or more light sources, which airflow path does not pass through the heated portion of the adsorbent material. The airflow path may be arranged to allow air from outside the air treatment device to pass through an unheated portion of adsorbent material.

The photocatalytic reactor may comprise a first portion containing the photo-catalyst and a second portion containing the one or more light sources, the first portion being arranged to receive the contaminants desorbed from the heated portion of the adsorbent material and the second portion being arranged to receive at least a portion of the airflow that has not passed through the heated portion of the absorbent material.

The photocatalytic reactor may comprise an at least partially transparent partition that separates the one or more light sources from the photo-catalyst, the partition separating the first portion from the second portion. The partition may be impermeable to air.

The air treatment device may comprise a desorption chamber that is arranged to surround a portion of the adsorbent material with the heater being arranged to heat the portion of the adsorbent material that is surrounded by the desorption chamber. The air treatment device may be arranged such that an unheated portion of adsorbent material is located outside the desorption chamber and is not exposed to the heat generated by heater,

The photo-catalyst may disposed upon one or more surfaces of the photocatalytic reactor, and the one or more light sources arranged to illuminate the one or more surfaces.

### DESCRIPTION OF THE DRAWINGS

The present invention will be described by way of example only with reference to the following figures of which:

FIG. 1 is a schematic representation of an example of an air treatment device;

FIG. 2 is a cut-away view of an example of an air treatment device;

FIG. 3 is an expanded cut-away view of the air treatment device of FIG. 2;

FIG. 4 is a schematic representation of a further example of an air treatment device;

FIG. 5A is a perspective view of an example of a filter suitable for use with the air treatment devices described herein;

FIG. 5B is a plan view of the filter of FIG. 5A;

FIG. 6A is a perspective view of an example of a filtration arrangement suitable for use with the air treatment devices described herein; and

FIG. 6B is a front view of the filtration arrangement of FIG. 6A.

### DETAILED DESCRIPTION

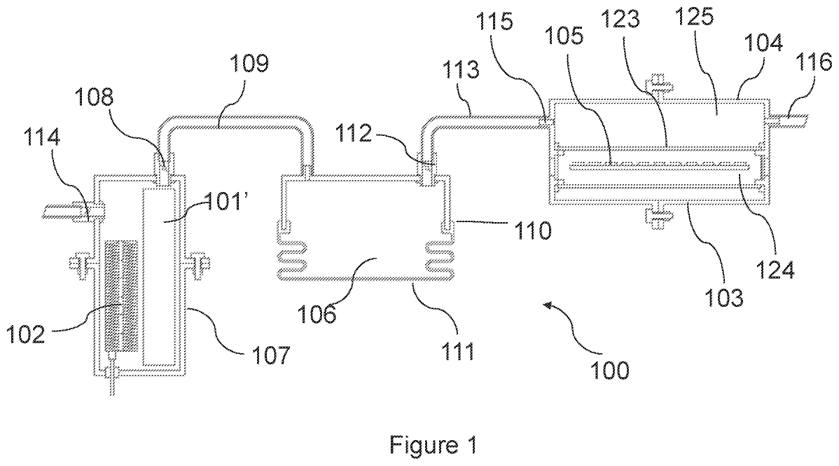

An example of an air treatment device will now be described by way of example only with reference to FIGS. 1, 2 and 3. The air treatment device is denoted generally by reference number 100, and comprises an outer casing 131 housing an airflow generator 120 for generating an air flow through the air treatment device 100.

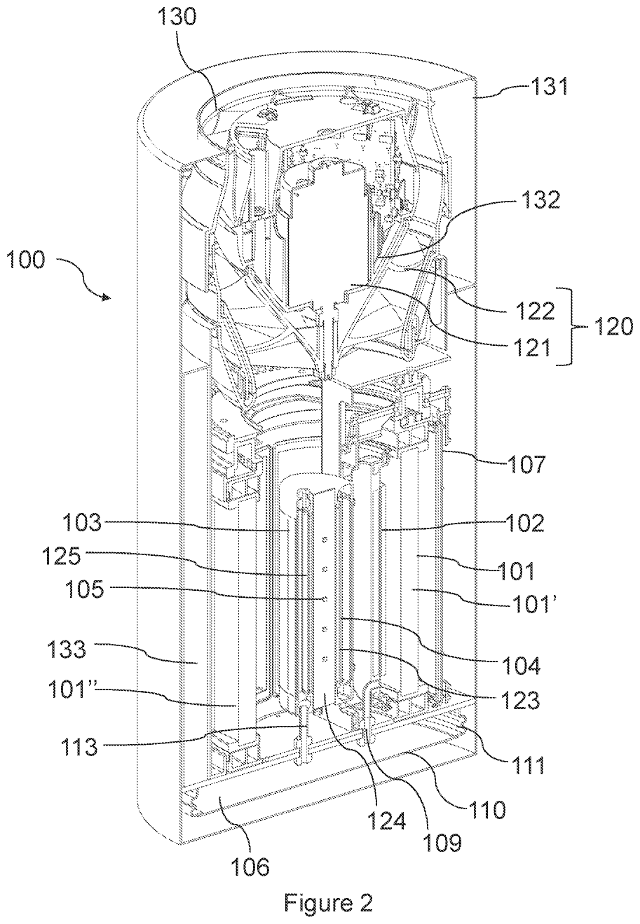

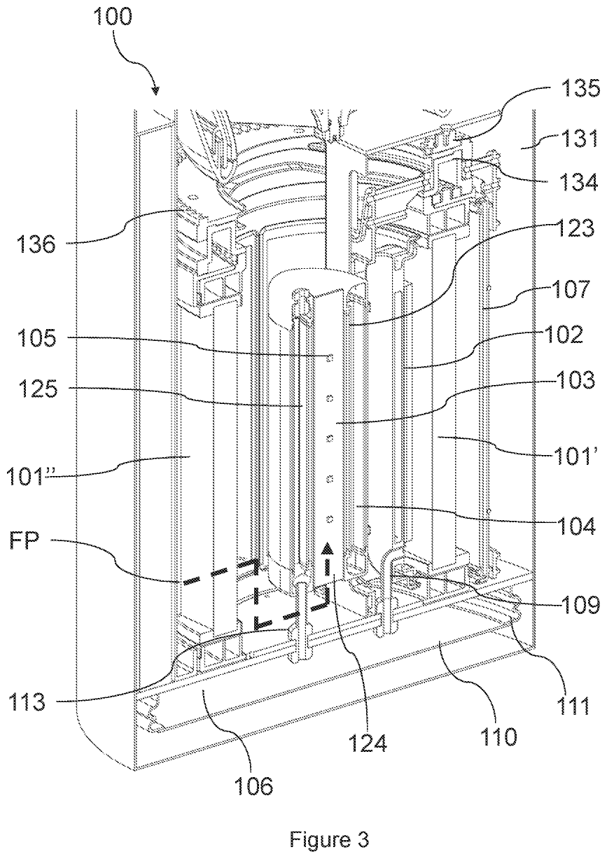

In the example shown in FIGS. 2 and 3, the outer casing 131 is cylindrical and has a side wall, a lower end and an upper end. The lower end is enclosed and provides a base (i.e. lower surface) upon which the air treatment device 100 rests (i.e. is supported). An air inlet of the air treatment device 100 is then provided in the side wall of the outer casing 131 and comprises an array of apertures (not shown) formed in the side wall of the outer casing 131. Alternatively, the air inlet could comprise one or more grilles or meshes mounted within windows formed in the outer casing 131.

The airflow generator 120 is then mounted within the outer casing 131, with an exhaust of the airflow generator 120 disposed within a circular aperture 130 provided in the upper end of the outer casing 131 such that the airflow exhausted from the airflow generator 120 exits the outer casing 131 of the air treatment device 100 through the aperture 130. The circular aperture 130 thereby provides an air outlet for the air treatment device 100.

The airflow generator 120 comprises a motor 121 and an impeller 122 that is arranged to be driven by the motor 121 to generate the airflow through the air treatment device 100. The impeller 122 has a general frusto-conical shape, and the motor 121 is partially disposed within a cavity 132 defined by a rear of the impeller 122.

The air treatment device 100 further comprises an adsorbent material 101 for adsorbing one or more airborne contaminants. The adsorbent material 101 is arranged such that at least a portion of the airflow that passes through the air treatment device 100 passes through the adsorbent material 101, so that contaminants present in that portion of the airflow are removed by the adsorbent material 101.

In the example shown in FIGS. 2 and 3, the adsorbent material 101 is provided by a plurality of curved monolithic carbon filters 101′, 101″ that are distributed around the inner circumference of the outer casing 131 such that they are downstream of the air inlet of the air treatment device 100, which is provided in the side wall of the outer casing 131, and upstream of the airflow generator 120. Airflow drawn through the air inlet of the air treatment device 100 by airflow generator 120 therefore passes through a curved monolithic carbon filter 101′, 101″ before being exhausted through the air outlet 130 of the airflow generator 120.

In the example shown in FIGS. 2 and 3, air treatment device 100 further comprises a pre-filter assembly 133 for pre-filtering of the airflow that passes through the air treatment device 100 before the airflow passes through the adsorbent material 101, with this pre-filter assembly 133 comprising a particulate filter media for filtering particulates from the airflow. For example, this particulate filter media could comprise a pleated polytetrafluoroethylene (PTFE) or glass microfiber nonwoven fabric. The pre-filter assembly 133 could also further comprise a chemical filter media for filtering certain chemicals from the before the airflow passes through the adsorbent material 101. For example, this chemical filter media could comprise an activated carbon filter media such as a pleated carbon cloth or activated carbon granules retained between layers of air-permeable material.

The air treatment device 100 also comprises a desorption assembly 102, 107 arranged to intermittently or periodically desorb contaminants from at least a portion of the adsorbent material 101. To do so, the desorption assembly comprises a desorption chamber 107 that is arranged to interchangeably surround different portions of the adsorbent material 101 and a heater 102 arranged to heat the adsorbent material that is surrounded by the desorption chamber 107 in order to desorb adsorbed contaminants. The desorption chamber 107 is also arranged to at least temporarily contain contaminants desorbed from the heated portion 101′ of adsorbent material 101.

In the example shown in FIGS. 2 and 3, the desorption assembly is rotatably mounted within the air treatment device 100 such that the desorption chamber 107 and the heater 102 can be rotated in order to move from one of the curved monolithic carbon filters 101′, 101″ to the other and thereby intermittently or periodically interchange which portion of the adsorbent material 101 is disposed within the desorption chamber 107. The air treatment device 100 therefore also comprises a rotation assembly that is arranged to rotate the desorption assembly, the rotation assembly comprising a rotation motor 134 that is arranged to rotate a drive member 135 and a driven member 136 that is arranged to be driven by the drive member 135 to rotate the desorption assembly around a rotation axis. In the example shown in FIGS. 2 and 3, the drive member 135 comprises a pinion and the driven member 136 comprises an at least partially circular or arcuate rack that is provided on the desorption assembly.

In alternative arrangement, the desorption assembly could be fixedly mounted within the air treatment device 100, with the adsorbent material 101 then being rotatably mounted within the outer casing 131 such that portions of the adsorbent material 101 can be rotated into and out of the desorption chamber 107 in order to intermittently or periodically interchange which portion of the adsorbent material 101 is disposed within the desorption chamber 107. In a further alternative arrangement, the desorption assembly could be arranged to move longitudinally (i.e. vertically) within the air treatment device 100 to move from one portion of the adsorbent material 101 to another and thereby intermittently or periodically interchange which portion of the adsorbent material 101 is disposed within the desorption chamber 107.

A photocatalytic reactor 103, 104, 105 is arranged to receive air containing the contaminants desorbed from the heated portion 101′ of adsorbent material. In the example of FIG. 2, air containing the contaminants desorbed from the heated portion 101′ of adsorbent material 101 passes from the desorption chamber 107 through conduit 109, into spacer volume 106, through conduit 113 and into the photocatalytic reactor 103. The photocatalytic reactor 103 comprises a reactor chamber 103 that is arranged to receive air containing the desorbed contaminants, a photo-catalyst 104 for photocatalytic degradation of one or more of the contaminants (such as titanium dioxide, TiO₂) that is disposed on one or more surfaces within the reactor chamber 103, and one or more light sources 105 for illuminating the photo-catalyst to facilitate photocatalytic degradation of the one or more contaminants. In the example shown in FIGS. 2 and 3, the light sources 105 are light emitting diodes that are mounted on an elongate printed circuit board (PCB), with these light emitting diodes emitting ultra-violet (UV) light at a wavelength of approximately 365 nm.

Air treatment device 100 is configured to provide at least one air flow path (FP) that allows air from outside the device 100 to contact at least one of the one or more light sources 105, which flow path (FP) does not pass through the heated portion 101′ of the adsorbent material 101. Specifically, air flows along flow path (FP) through an unheated portion 101″ of adsorbent material 101. This unheated portion 101″ of adsorbent material 101 is located outside the desorption chamber 107 and therefore is not exposed to the heat generated by heater 102, such that filtered air passes over the light sources 105 without passing through a heated part of the adsorbent material 101. As described below, this unheated air passes over, and cools, the one or more light sources 105.

The reactor chamber 103 comprises a transparent barrier or partition 123 that separates the photo-catalyst 104 from the one or more light sources 105. The transparent partition 123 comprises a material that is sufficiently transparent to the ultra-violet (UV) light emitted by the one or more light sources 105 such that the light of a catalysing UV wavelength passing through the transparent partition 123 is sufficiently intense to catalyse breakdown of contaminants by the photo-catalyst 104.

The reactor chamber 103 therefore comprises a first portion 125 containing the photo-catalyst and a second portion 124 containing the one or more light sources 105 with the transparent partition 123 separating the first portion 125 from the second portion 124. The first portion 125 is arranged to receive air containing the contaminants desorbed from the heated portion 101′ of the adsorbent material and the second portion 124 is arranged to receive at least a portion of the airflow that has not passed through the heated portion 101′ of the adsorbent material 101, but has passed through unheated portion 101″ of the adsorbent material 101. To do so, the transparent partition 123 is arranged such that air that has passed through unheated portion 101″ of the adsorbent material 101 can flow through second portion 124. In particular, the transparent partition 123 provides a conduit within which the one or more light sources 105 are located.

The air treatment device 100 decreases the likelihood of the photo-catalyst 104 being “poisoned” by exposure to too much contaminant by providing a spacer volume 106 into which contaminants adsorbed by the adsorbent material 101 may be released and stored prior to being delivered into the photo-catalytic reactor. The spacer volume 106 is therefore arranged to receive and retain air containing the desorbed contaminants that is received from the desorption assembly. In addition, the air treatment device 100 may further comprise a diluent gas inlet (not shown) that is arranged to allow for the introduction of diluent gas into the spacer volume and a diluent gas inlet valve (not shown) that is arranged to control the introduction of diluent gas through the diluent gas inlet. The introduction of diluent gas into the spacer volume allows for the concentration of the contaminants containing within the spacer volume to be reduced, further reducing the likelihood of the photo-catalyst 104 being “poisoned” by exposure to too much contaminant.

Operation of the device of FIGS. 1, 2 and 3 will now be described with reference to FIGS. 1, 2 and 3 that show the air treatment device 100. Rotation of the impeller 122 by the motor 121 generates an airflow through the air inlet of the air treatment device 100, with this airflow passing through a portion of the adsorbent material 101 that is not disposed within the desorption chamber 107. The air treatment device 100 subsequently determines that this portion of the adsorbent material 101 requires regeneration and therefore initiates a regeneration process for this portion of the absorbent material 101. In a first step of the regeneration process, the portion of the adsorbent material 101 that is to be regenerated is disposed, and preferably sealed, within the desorption chamber 107. In the example shown in FIGS. 2 and 3, this step involves actuation of the rotation assembly in order to rotate the desorption assembly and thereby interchange the curved monolithic carbon filter that is currently disposed within the desorption chamber 107 with the curved monolithic carbon filters 101′ that is to be regenerated.

In a second step of the regeneration process, the heater 102 is activated in order to heat the portion 101′ of the adsorbent material 101 that is surrounded by the desorption chamber 107 in order to desorb adsorbed contaminants. Before or during the heating of the portion 101′ of the adsorbent material 101, a spacer volume inlet valve 108 disposed between the desorption chamber 107 and the spacer volume 106 is opened, permitting air and contaminants to move from the desorption chamber 107 to the spacer volume 106, and a spacer volume outlet valve 112 disposed between the spacer volume 106 and the reactor chamber 103 of the photocatalytic reactor is closed, preventing air containing desorbed contaminants from reaching the photocatalytic reactor. This approach does not require slow and precisely controlled heating of the adsorbent material 101 but rather allows for rapid heating and desorption. In addition, a desorption chamber inlet valve 114 is opened before or during the heating of the portion 101′ of the adsorbent material 101 in order to allow air into the desorption chamber 107 and thereby prevent the desorption chamber 107 from becoming negatively pressurised.

Whilst the movement of desorbed contaminants from the desorption chamber 107 to the spacer volume 106 can be achieved solely using thermal expansion resulting from the heating by the heater 102, movement of the air and contaminants from the desorption chamber 107 to the spacer volume 106 during the second step may be facilitated by increasing the volume of a spacer chamber 110 that defines the spacer volume 106. For example, this can be achieved by moving a movable portion 111 of the spacer chamber 110. The movable portion 111 may then comprise pleats or folds that facilitate expansion of the spacer chamber 110. In the example shown in FIGS. 2 and 3, the spacer chamber 110 is a relatively flat cylindrical chamber located towards the bottom of the air treatment device 100.

In a third step of the regeneration process that is initiated once desorption is determined to be complete, the spacer volume inlet valve 108 between the desorption chamber 107 and the spacer volume 106 is closed. The heater 102 can then be deactivated and the heated portion 101′ of the adsorbent material 101 is permitted to cool. The spacer volume outlet valve 112 is at least partially opened, allowing air containing the desorbed contaminants to be delivered to the photocatalytic reactor from the spacer volume 106. In the example shown in FIGS. 2 and 3, the spacer volume outlet valve 112 is opened sufficiently to provide a constant, controlled flow of air and contaminants to the reactor chamber 103 of the photocatalytic reactor, the flow rate being sufficiently limited so that a desired amount of contaminants (e.g. substantially all) can be removed from the airflow without irrevocable poisoning of the photocatalyst 104.

In order to facilitate movement of the air and contaminants from the spacer volume 106 to the photocatalytic reactor during the third step, the volume of the spacer chamber 110 that defines the spacer volume 106 may be decreased. For example, this can be achieved by moving the movable portion 111 of the spacer chamber 110, with the pleats or folds of the movable portion 111 facilitating contraction of the spacer chamber 110. It is then possible to control the flow of air containing the desorbed contaminants to the photocatalytic reactor by controlling the contraction of the spacer chamber 110.

During this third step, the light sources 105 of the photocatalytic reactor are activated such that they illuminate the photocatalyst 104 disposed on one or more surfaces within the reactor chamber 103. Consequently, the air delivered to the reactor chamber 103 from the spacer volume 106 is treated by photocatalytic degradation of desorbed contaminants that are present in the air. In the example shown in FIGS. 1, 2 and 3, the delivery of air containing the desorbed contaminants from the spacer volume 106 to the reactor chamber 103 is performed at a controlled rate, and the photocatalytic reactor is arranged to treat the air as it flows through the reactor chamber 103. In particular, the photocatalytic reactor is arranged such that air delivered to the reactor chamber 103 from the spacer volume 106 enters the reactor chamber 103 through a reactor inlet 115, flows through the reactor chamber 103 at a controlled rate, and is emitted from a reactor outlet 116, with treatment of the air by photocatalytic degradation taking place whilst the air flows from the reactor inlet 115 to the reactor outlet 115.

After passing through the photocatalytic reactor 103, the airflow may be emitted from the air treatment device 100. Alternatively, the air treatment device 100 may be arranged such that air emitted from the photocatalytic reactor passes through a filter, such as the adsorbent material 101 before the airflow leaves the air treatment device 100. For example, the photocatalytic reactor may be arranged to emit treated air so that the treated air passes through at least a portion of the adsorbent material 101 before being emitted from the air treatment device 100. This approach provides that any contaminants that have not been entirely degraded within the photocatalytic reactor, and that therefore remain within the treated air, may still be adsorbed by the adsorbent material 101 before the treated air is emitted from the air treatment device 100.

Those skilled in the art will realise that more than one chamber may be used to define the spacer volume. Similarly, one or more conduits may be used in conjunction with, or instead of, one or more chambers to define the spacer volume. Such multiple conduits and chambers may be used in series and/or in parallel to define the spacer volume.

The example described above demonstrates how the heated portion 101′ may comprise a first filter and the non-heated portion 101″ may comprise a second filter. It would be possible, of course, for both the heated portion 101′ and the non-heated portion 101″ to be provided by one filter.

In the example shown in FIGS. 1, 2 and 3, the air treatment device 100 is a domestic air filtration/purification unit. Those skilled in the art will realise that the air treatment device may be an air conditioning unit, typically used to cool and/or heat air. Alternatively or additionally, the air treatment device may be a commercial air treatment unit, for example, suitable for use in public areas.

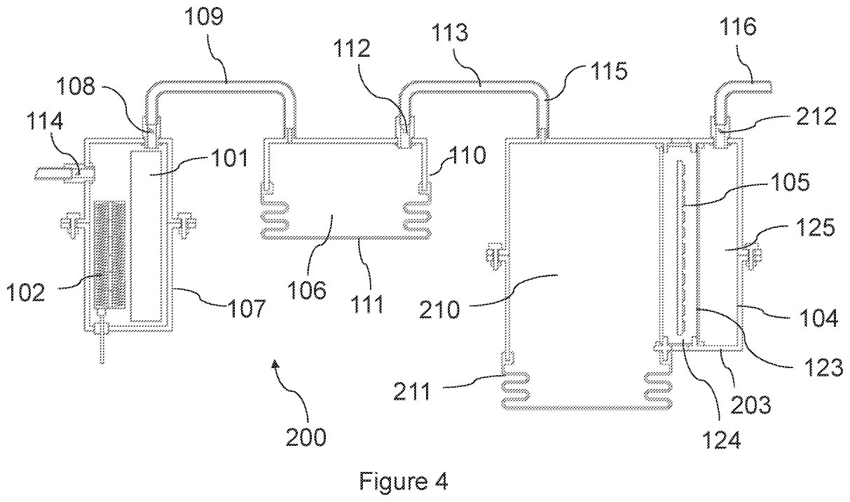

Another example of an air treatment device in accordance with the present invention will now be described with reference to FIG. 4. The air treatment device 200 is similar to that described above with reference to FIGS. 1, 2 and 3, in that the device 200 comprises a spacer volume 106 arranged to receive air containing contaminants desorbed from a heated portion 101′ of an adsorbent material 101. Features in FIG. 4 having the same reference numerals as in FIGS. 1, 2 and 3 correspond to those features described in relation to FIGS. 1, 2 and 3, and operate in the same way.

In the example shown in FIG. 4, the reactor chamber 103 of the photocatalytic reactor is arranged to store air containing contaminants that is received from the spacer volume 106 prior to allowing treated air to be emitted from the photocatalytic reactor. The reactor chamber 103 is therefore arranged to receive and retain air containing desorbed contaminants that is received from the spacer volume 106. To do so, the photocatalytic reactor comprises a reactor inlet 115 through which air containing desorbed contaminants is received from the spacer volume 106, a reactor outlet 116 arranged to emit treated air from within the photocatalytic reactor and a reactor outlet valve 212 for controlling emission of treated air from the photocatalytic reactor. In order to maintain the pressure within the reactor chamber 103 when receiving air containing desorbed contaminants from the spacer volume 106, the volume of the reactor chamber 103 may be increased. For example, this can be achieved by moving a movable portion 211 of the reactor chamber 103. The movable portion 211 may then comprise pleats or folds that facilitate expansion and contraction of the reactor chamber.

In use, a batch of air containing contaminants may be passed from the spacer volume 106 by opening the spacer volume outlet valve 112. In order to facilitate movement of the air and contaminants from the spacer volume 106 to the photocatalytic reactor, the volume of the spacer chamber 110 that defines the spacer volume 106 may be decreased. For example, this can be achieved by moving the movable portion 111 of the spacer chamber 110, with the pleats or folds of the movable portion 111 facilitating contraction of the spacer chamber 110. It is then possible to control the flow of air containing the desorbed contaminants to the photocatalytic reactor by controlling the contraction of the spacer chamber 110.

Movement of movable portion 211 to expand the reactor chamber 103 maintains the pressure within the reactor chamber 103 and may also act to draw air containing the desorbed contaminants from spacer volume 106 to the reactor chamber 103. The reactor outlet valve 212 is closed during the transfer of air containing the desorbed contaminants into the reactor chamber 103 such that it is retained within the reactor chamber 103.

Once the “batch” of air has been transferred to the reactor chamber 103, the spacer volume outlet valve 112 is closed and the air in the reactor chamber 103 is treated by activating the light sources 105 of the photocatalytic reactor such that they illuminate the photocatalyst 104 disposed on one or more surfaces within the reactor chamber 103. Consequently, the air contained within the reactor chamber 103 is treated by photocatalytic degradation of desorbed contaminants that are present in the air. Once treatment is complete, treated air is allowed to leave the photocatalytic reactor by opening the reactor outlet valve 212. Movement of moveable portion 211 so as to cause the volume of the reactor chamber 103 to reduce again maintains the pressure within the reactor chamber 103 and may also act to urge treated air out of the photocatalytic reactor.

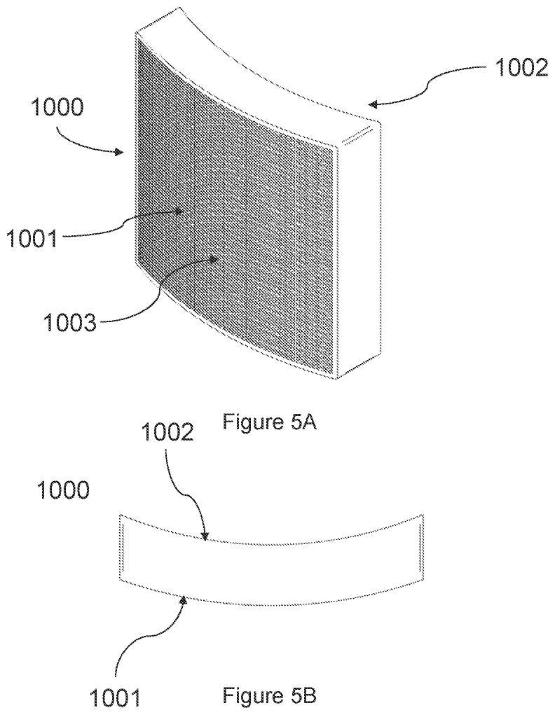

FIGS. 5A and 5B illustrate an example of an absorption filter suitable for use with the air treatment devices described herein. The adsorption filter is denoted generally by reference number 1000. The filter 1000 comprises a carbon-based adsorbent material, such as an activated carbon, and is monolithic. Specifically, the filter 1000 has a rigid, open structure comprising an inlet face 1001 for the introduction of an inlet gas, such as air, to be filtered and an outlet face 1002 opposite the inlet face. The filter 1000 further comprises a plurality of channels 1003 that extend from the inlet face 1001 to the outlet face 1002. The plurality of channels 1003 may comprise any of a regular array of channels and an irregular network of channels and/or open pores.

In the example illustrated in FIGS. 5A and 5B, both the inlet face 1001 and the outlet face 1002 are curved. As can be seen from FIG. 5B in particular, inlet face 1001 and outlet face 1002 have the same curvature, with the curvature of both the inlet face and outlet face being circular cylindrical. However, this need not be the case. For example, the inlet and outlet faces may be have different curvatures. It may be, for example, that the curvature of the outlet face may be greater than that of the inlet face. The provision of curved inlet and outlet faces provides a more adaptable filter and facilitates filtration in differing geometries. In particular, an absorption filter such as that described above is optimised for use within a circumferential array of filters disposed within an at least partially cylindrical air treatment device. Such an absorption filter also facilitates the use of a rotation assembly to implement the intermittent or periodical interchanging of the filters that are disposed within the desorption chamber.

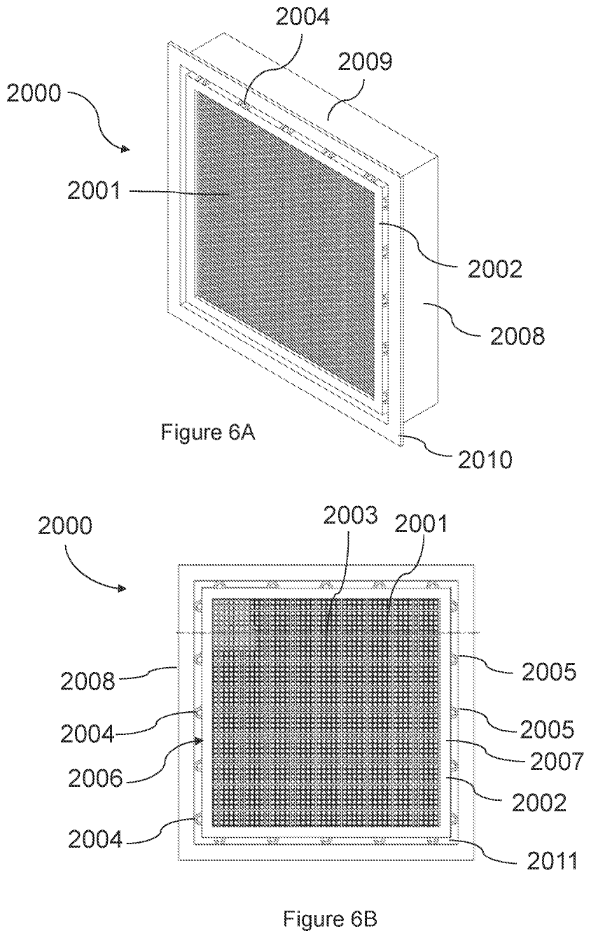

FIGS. 6A and 6B illustrate an example of a filtration arrangement suitable for use with the air treatment devices described herein. The filtration arrangement is generally denoted by reference number 2000, and comprises a monolithic adsorption filter 2001 and a carrier 2002, the filter being retained within a carrier aperture 2003 defined by the carrier 2002. The carrier 2002 comprises a plurality of elastically-deformable supports 2004 distributed around a periphery 2006 of the carrier 2002. The elastically-deformable supports 2004 reduce the likelihood of damage occurring to the filter 2001, should the filtration arrangement 2000 be subjected to undesirable impact. The supports provide cushioning that reduces the risk of the filter 2001 being damaged.

In the example illustrated in FIGS. 6A and 6B, the carrier 2002 is integrally formed from silicone, with the carrier 2002 comprising a filter-retaining portion 2007 that is integrally formed with the elastically-deformable supports 2004. However, those skilled in the art will realise that the carrier need not be integrally formed. For example, the filter-retaining portion 2007 need not be integrally formed with the supports 2004.

In the illustrated example, the elastically-deformable supports 2004 are provided by a plurality of projections 2005 arranged about the periphery of the carrier. In this example, each deformable projection 2005 has the form of radially damping profile damper. However, those skilled in the art will realise that other arrangements of elastically-deformable support may be used. For example, each support may be in the form of an axially damping profile damper. Alternatively, the filtration arrangement may be provided with different types of support, for example, some radially damping profile dampers and some axially damping profile dampers.

In the example illustrated in FIGS. 6A and 6B, the filtration arrangement 2000 further comprises a casing 2008, with the carrier 2002 being received within a casing aperture 2011 defined by the casing 2008. The casing aperture 2011 and carrier 2002 are configured so that the supports 2004 at least partially deform on receipt of the carrier 2002 within the casing aperture 2011. In the illustrated example, the casing 2008 comprises an aperture-defining main body portion 2009 and a flange portion 2010 extending around the periphery of the aperture-defining main body portion 2009. The casing 2008 is integrally-formed from a plastics material. In use, the aperture-defining main body portion 2009 is received in a suitable aperture of an air treatment device (neither of which are shown).

Those skilled in the art will realise that other shapes of filter may be used. For example, the filter need not be square or rectangular, it may be circular.

For the avoidance of doubt, those skilled in the art will realise that the casing is not an essential part of the filtration arrangement of the present aspect of the invention.

Those skilled in the art will realise that the filtration arrangement described above may be used with the other arrangements described herein. For example, the filtration arrangement may be used with a filter with one or more curved faces such as that described above in relation to FIG. 5A and 5B. Furthermore, the filtration arrangement may be used in an air treatment device as described above in relation to FIGS. 1 to 3.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An air treatment device comprising:
an airflow generator for generating an airflow;
an adsorbent material for adsorbing one or more airborne contaminants, the adsorbent material being arranged such that at least a portion of the airflow passes through the adsorbent material;
a heater arranged to heat at least a portion of the adsorbent material to desorb adsorbed contaminants; and
a photocatalytic reactor arranged to receive the contaminants desorbed from the heated portion of adsorbent material;
wherein the photocatalytic reactor comprises a photo-catalyst for photocatalytic degradation of one or more of the contaminants, and one or more light sources for illuminating the photo-catalyst to facilitate photocatalytic degradation; and
wherein the air-treatment device is arranged such that at least a portion of the air flow that has not passed through the heated portion of the adsorbent material contacts the one or more light sources.

2. The air treatment device of claim 1, wherein the air treatment device is configured to provide at least one airflow path that allows air from outside the air treatment device to contact at least one of the one or more light sources, which airflow path does not pass through the heated portion of the adsorbent material.

3. The air treatment device of claim 2, wherein the airflow path is arranged to allow air from outside the air treatment device to pass through an unheated portion of adsorbent material.

4. The air treatment device of claim 1, wherein the photocatalytic reactor comprises a first portion containing the photo-catalyst and a second portion containing the one or more light sources, the first portion being arranged to receive the contaminants desorbed from the heated portion of the adsorbent material and the second portion being arranged to receive at least a portion of the air flow that has not passed through the heated portion of the absorbent material.

5. The air treatment device of claim 4, wherein the photocatalytic reactor comprises an at least partially transparent partition that separates the one or more light sources from the photo-catalyst, the partition separating the first portion from the second portion.

6. The air treatment device of claim 1, wherein the air treatment device comprises a desorption chamber arranged to surround a portion of the adsorbent material and the heater is arranged to heat the portion of the adsorbent material that is surrounded by the desorption chamber.

7. The air treatment device of claim 6, wherein an unheated portion of adsorbent material is located outside the desorption chamber and is not exposed to the heat generated by heater.
